(19) United States
(12) Patent Application Publication
(10) Pub. No.: US 2025/0242588 A1
(43) Pub. Date: Jul. 31, 2025

(54) LIQUID EJECTION HEAD AND PRINTER

(71) Applicant: BROTHER KOGYO KABUSHIKI KAISHA, Nagoya (JP)

(72) Inventor: Rie JOBOJI, Nagoya (JP)

(21) Appl. No.: 18/974,891

(22) Filed: Dec. 10, 2024

(30) Foreign Application Priority Data
Jan. 31, 2024 (JP) 2024-013387

(51) Int. Cl. B41J 2/14

(52) U.S. Cl. CPC B41J 2/1408; B41J 2/14072; B41J 2002/14491; B41J 2202/08

(57) ABSTRACT

An actuator member has an upper surface including a first contact region in which a first contact is disposed and a first outer peripheral region surrounding the first contact region. A wiring member includes a connection portion including a second contact region and a second outer peripheral region. The second contact region overlaps with the first contact region in a perpendicular direction. A second contact is disposed in the second contact region. The second outer peripheral region overlaps with the first outer peripheral region in the perpendicular direction. A pressing member contacts the second outer peripheral region without contacting the second contact region. The pressing member presses the second outer peripheral region toward the actuator member. A thermal interface material contacts the second contact region without contacting the second outer peripheral region. The thermal interface material has a lower hardness than the pressing member.

### REFERENCE TO RELATED APPLICATIONS

This application claims priority from Japanese Patent Application No. 2024-013387 filed on Jan. 31, 2024. The entire content of the priority application is incorporated herein by reference.

### BACKGROUND ART

A liquid ejection head that ejects liquid from a nozzle is known.

### SUMMARY

For example, in a liquid ejection head, a COF (wiring member) includes a connection portion disposed on an upper surface of an actuator (actuator member) and connected to a contact (first contact) on the upper surface of the actuator. A pressing member is disposed on an upper surface of the connection portion. A lower surface of the pressing member has an annular pressing portion along the edge of the pressing member and a recessed portion inside the pressing portion. The pressing portion presses an outer peripheral portion of the connection portion, and the recessed portion faces a central portion of the connection portion with a gap therebetween. The central portion is an example of a region where the contact of the actuator is disposed.

The pressing member prevents the wiring member from being separated from the actuator member by the pressing force of the pressing portion, and does not apply a load to a bonding portion of the contact due to the recessed portion. However, heat of the actuator member is accumulated in the recessed portion, and the heat is transmitted to a channel member and further to the liquid in the channel member, and thus the ejection performance of the liquid from the nozzle of the channel member is changed.

In view of the foregoing, an example of an object of this disclosure is to provide a liquid ejection head configured to release heat of an actuator member without applying a load to a bonding portion of a contact while preventing a wiring member from separating from the actuator member.

According to one aspect, this specification discloses a liquid ejection head. The liquid ejection head includes a channel member, an actuator member, a wiring member, a pressing member, and a thermal interface material. The channel member has a liquid channel including a nozzle. The actuator member is disposed on an upper surface of the channel member. The actuator member has an upper surface including a first contact region in which a first contact is disposed and a first outer peripheral region surrounding the first contact region. The actuator member is configured to cause the nozzle to eject liquid. The wiring member includes a connection portion disposed on the upper surface of the actuator member. The connection portion includes a second contact region and a second outer peripheral region. The second contact region overlaps with the first contact region in a perpendicular direction perpendicular to the upper surface of the actuator member. A second contact electrically connected to the first contact is disposed in the second contact region. The second outer peripheral region overlaps with the first outer peripheral region in the perpendicular direction. The pressing member is disposed above the connection portion. The pressing member contacts the second outer peripheral region without contacting the second contact region. Thus, the pressing member does not apply a load to the second contact region. The pressing member is configured to press the second outer peripheral region toward the actuator member. Thus, the pressing member suppresses separation of the wiring member from the actuator member. The thermal interface material is disposed above the connection portion. The thermal interface material contacts the second contact region without contacting the second outer peripheral region. The thermal interface material has a lower hardness than the pressing member. Thus, the thermal interface material does not apply a load to the second contact region.

According to the present disclosure, the pressing member presses the second outer peripheral region of the connection portion toward the actuator member, thereby suppressing the wiring member from being separated from the actuator member. Further, the thermal interface material having a low hardness contacts the second contact region of the connection portion, thereby releasing the heat of the actuator member without applying a load to the bonding portion of the contact.

### BRIEF DESCRIPTION OF DRAWINGS

FIG. 1 is a plan view of a printer 100.

FIG. 2 is a cross-sectional view of a head 10 included in the printer 100.

FIG. 3 is a perspective view of the head 10.

FIG. 4 is a plan view of the head 10.

FIG. 5 is a cross-sectional view of the head 10 taken along a line V-V in FIG. 4.

FIG. 6 is an enlarged view of a region VI shown in FIG. 5.

FIG. 7 is an exploded perspective view of a part of the head 10.

FIG. 8 is a schematic view showing a connection state among water cooling pipes 24, 25 and a water tank 29 provided in the head 10.

FIG. 9 is a graph showing temperature changes of heads associated with driving of an actuator member.

### DESCRIPTION

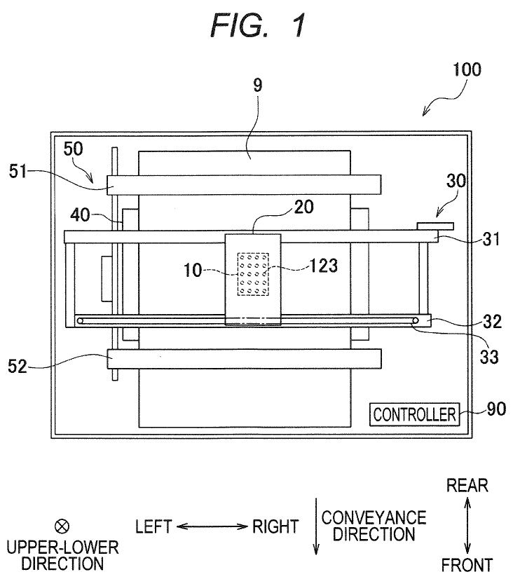

A printer 100 shown in FIG. 1 includes a head 10 which is an embodiment of “liquid ejection head” according to the present disclosure. In the following description, an upper-lower direction is defined based on a state where the printer 100 is installed to be usable, a front-rear direction is defined with a downstream side in a conveyance direction of a sheet 9 as a front side, and a left-right direction is defined when viewed from the front side of the printer 100.

The printer 100 includes the head 10, a carriage 20 that holds the head 10, a scanning mechanism 30 that moves the carriage 20 and the head 10 in the left-right direction, a platen 40 that supports the sheet 9 from below, a conveyance mechanism (conveyor) 50 that conveys the sheet 9 forward, and a controller 90.

The scanning mechanism 30 includes a pair of guides 31 and 32 that support the carriage 20, and a belt 33 that is connected to the carriage 20. The guides 31, 32 and the belt 33 extend in the left-right direction. When a carriage motor (not shown) is driven under the control of the controller 90, the belt 33 runs, and the carriage 20 and the head 10 move in the left-right direction along the guides 31 and 32.

The platen 40 is disposed below the carriage 20 and the head 10. The sheet 9 is supported on an upper surface of the platen 40.

The conveyance mechanism 50 includes a roller 51 disposed rearward of the head 10 and a roller 52 disposed forward of the head 10. The head 10, the carriage 20, and the platen 40 are disposed between the roller 51 and the roller 52 in the front-rear direction.

Each of the rollers 51 and 52 includes a set of rotating members. The set of rotating members includes an upper rotating member disposed above a conveyance path of the sheet 9 and a lower rotating member disposed below the conveyance path of the sheet 9. The upper rotating member and the lower rotating member are arranged such that their circumferential surfaces are in contact with each other.

When the conveyance motor is driven under the control of the controller 90, the respective rotating members of the rollers 51 and 52 rotate. The respective rotating members of the rollers 51 and 52 rotate while sandwiching the sheet 9 therebetween, thereby conveying the sheet 9 forward.

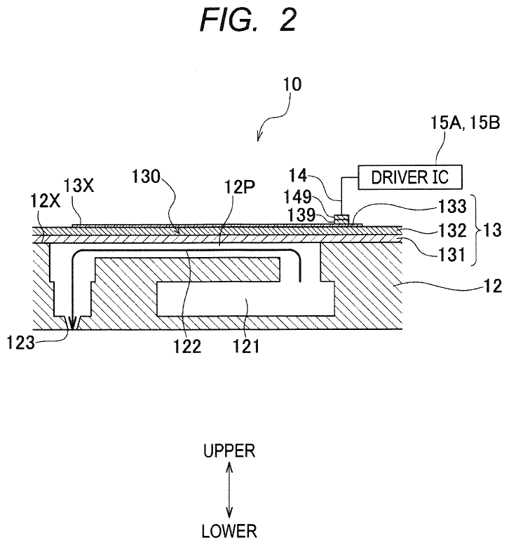

As shown in FIG. 2, the head 10 includes a channel member 12 and an actuator member 13.

A plurality of nozzles 123 are opened in the lower surface of the channel member 12. A common channel 121 communicating with an ink tank and individual channels 122 provided for respective ones of the plurality of nozzles 123 are formed inside the channel member 12. The individual channel 122 is a channel (flow path) from the outlet of the common channel 121 to the nozzle 123 via a pressure chamber 12P. A plurality of pressure chambers 12P are opened in an upper surface 12X of the channel member 12. The common channel 121 and the individual channels 122 are examples of “liquid channel” of the present disclosure.

The actuator member 13 is arranged on the upper surface 12X of the channel member 12. The actuator member 13 includes a metal vibration plate 131, a piezoelectric layer 132, and a plurality of individual electrodes 133. The vibration plate 131 is disposed on the upper surface 12X of the channel member 12 so as to cover the plurality of pressure chambers 12P. The piezoelectric layer 132 is disposed on the upper surface of the vibration plate 131. The plurality of individual electrodes 133 are disposed on the upper surface of the piezoelectric layer 132 so as to face respective ones of the plurality of pressure chambers 12P.

The vibration plate 131 and the plurality of individual electrodes 133 are electrically connected to driver ICs 15A and 15B via a COF (Chip on Film) 14. The driver ICs 15A and 15B are electrically connected to the controller 90. The COF 14 is an example of “wiring member” of the present disclosure. The driver ICs 15A and 15B are examples of “driver circuit” of the present disclosure.

On an upper surface 13X of the actuator member 13, contacts (not shown) which are disposed on the upper surface of the piezoelectric layer 132 and electrically connected to the vibration plate 131, and contacts 139 which are disposed on the upper surface 13X of the individual electrode 133 are disposed. The COF 14 includes contacts 149 which are electrically connected to the contacts disposed on the upper surface 13X, and signal lines which electrically connect the contacts 149 and the driver ICs 15A, 15B. The contact 139 is an example of “first contact” of the present disclosure. The contact 149 is an example of “second contact” of the present disclosure.

The driver ICs 15A and 15B change the potential of the individual electrode 133 while maintaining the potential of the vibration plate 131 at the ground potential under the control of the controller 90. As a result, the potential of the individual electrode 133 changes between a particular driving potential and the ground potential. At this time, an actuator 130, which is a portion of the vibration plate 131 and the piezoelectric layer 132 sandwiched between each individual electrode 133 and the corresponding pressure chamber 12P, is deformed, and thus the volume of the pressure chamber 12P is changed, and ink in the pressure chamber 12P is pressurized, and ink is ejected from the nozzle 123.

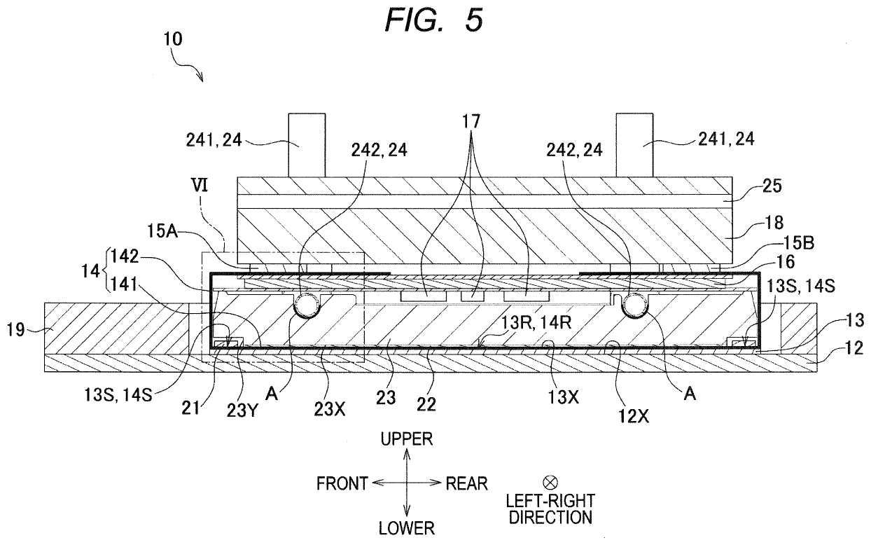

As shown in FIG. 5, the COF 14 includes a connection portion 141 disposed on the upper surface 13X of the actuator member 13, and two folded portions 142 folded upward from both ends of the connection portion 141 in the front-rear direction.

The connection portion 141 extends along the front-rear direction and the left-right direction in parallel with the upper surface 13X. As shown in FIG. 5, the upper surface 13X includes a contact region 13R in which the plurality of contacts 139 (see FIG. 2) are arranged, and an outer peripheral region 13S surrounding the contact region 13R. The connection portion 141 includes a contact region 14R that overlaps (faces) the contact region 13R in the upper-lower direction, and an outer peripheral region 14S that overlaps (faces) the outer peripheral region 13S in the upper-lower direction. The plurality of contacts 149 (see FIG. 2) are arranged in the contact region 14R. The contact regions 13R and 14R are rectangular, and the outer peripheral regions 13S and 14S have a rectangular frame shape.

The contact region 13R is an example of “first contact region” of the present disclosure, and the outer peripheral region 13S is an example of “first outer peripheral region” of the present disclosure. The contact region 14R is an example of “second contact region” of the present disclosure, and the outer peripheral region 14S is an example of “second outer peripheral region” of the present disclosure. The upper-lower direction is an example of “perpendicular direction” of the present disclosure.

Each of the two folded portions 142 includes a vertical portion extending upward from the end of the connection portion 141, and a horizontal portion extending forward or rearward from an upper end of the vertical portion toward a center of the head 10 in the front-rear direction. The driver IC 15A is disposed on the upper surface of the horizontal portion of the front folded portion 142 of the two folded portions 142, and the driver IC 15B is disposed on the upper surface of the horizontal portion of the rear folded portion 142.

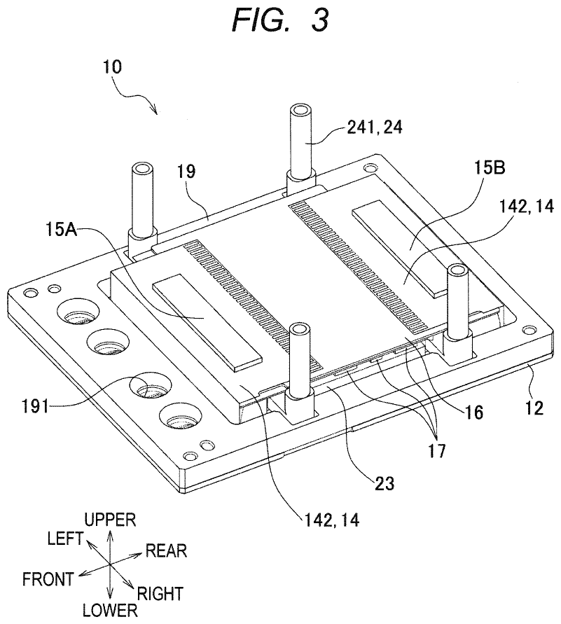

A frame 19 is disposed around the actuator member 13 on the upper surface 12X of the channel member 12. The frame 19 is a rectangular frame-shaped member disposed along the peripheral edge of the upper surface 12X. As shown in FIG. 3, four openings 191 are provided at a front end of the frame 19. Each opening 191 communicates with the common channel 121 of the channel member 12 and communicates with the ink tank via a tube. For example, the ink in the ink tank flows into the common channel 121 via the tube and the four openings 191.

As shown in FIG. 5, the actuator member 13 and the COF 14 are arranged within the frame 19. A pressing member 21, heat dissipation members 22 and 23, a support member 16, and circuit boards 17 are arranged in a space surrounded by the connection portion 141 and the two folded portions 142 of the COF 14. The pressing member 21, the heat dissipation members 22 and 23, the support member 16, and the circuit boards 17 are arranged above the connection portion 141. The heat dissipation member 22 is an example of “thermal interface material (first heat dissipation member)” of the present disclosure, and the heat dissipation member 23 is an example of “first heat sink (second heat dissipation member)” of the present disclosure.

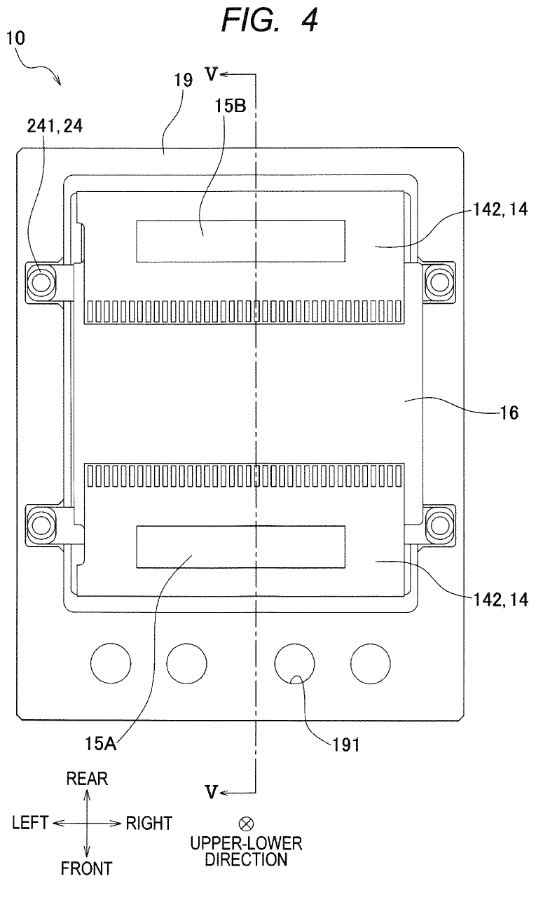

As shown in FIGS. 3 and 4, the channel member 12 and the frame 19 have a rectangular shape elongated in the front-rear direction in a plane perpendicular to the upper-lower direction. The actuator member 13, the pressing member 21, the heat dissipation members 22 and 23, and the support member 16 also have a rectangular shape elongated in the front-rear direction in a plane perpendicular to the upper-lower direction.

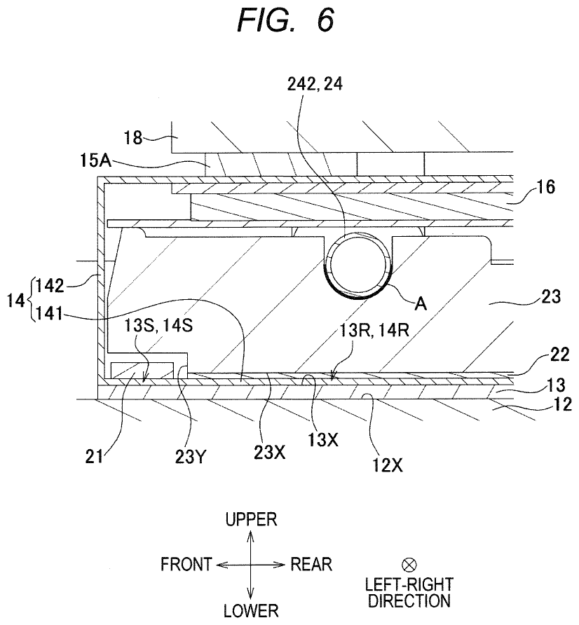

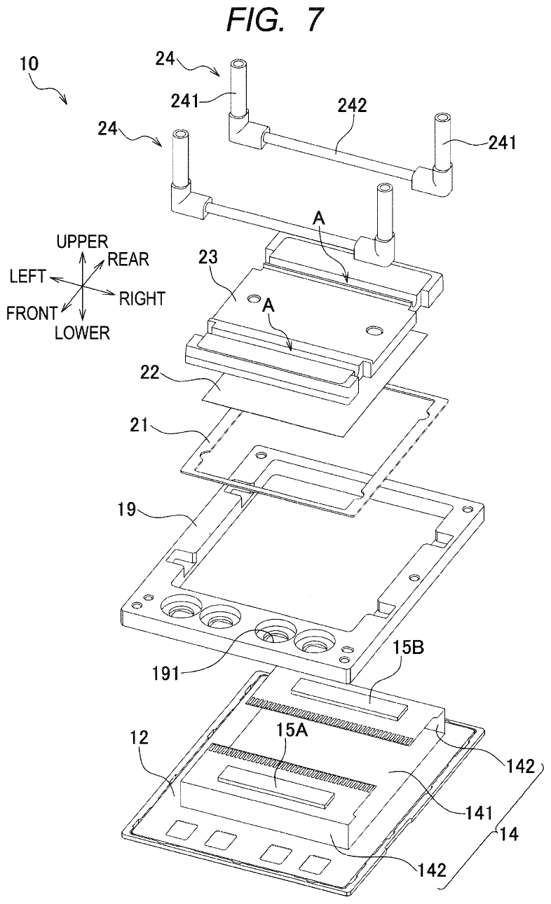

As shown in FIG. 7, the pressing member 21 (pressing plate or pressing frame) is a plate member having a rectangular frame shape in a plane perpendicular to the upper-lower direction. Although not shown, the heat dissipation member 23 contacts the pressing member 21, and the heat dissipation member 23 presses the pressing member 21 downward. As shown in FIGS. 5 and 6, the pressing member 21 does not contact the contact region 14R but contacts the outer peripheral region 14S, and presses the outer peripheral region 14S downward toward the actuator member 13. The pressing member 21 may be made of resin, metal, and so on.

As shown in FIG. 7, the heat dissipation member 22 is a sheet member having a rectangular shape in a plane perpendicular to the upper-lower direction. As shown in FIGS. 5 and 6, the heat dissipation member 22 is disposed within the frame of the pressing member 21, and does not contact the outer peripheral region 14S but contacts the contact region 14R. The heat dissipation member 22 is made of a gel and has a hardness lower than that of the pressing member 21. Gels are forms of matter intermediate between solids and liquids.

As shown in FIG. 7, the heat dissipation member 23 is a member having a rectangular shape in a plane perpendicular to the upper-lower direction. As shown in FIGS. 5 and 6, the heat dissipation member 23 is disposed above the heat dissipation member 22. The lower surface of the heat dissipation member 23 has a central region 23X and a recess 23Y formed in an outer peripheral region surrounding the central region 23X. The central region 23X overlaps (faces) the contact regions 13R and 14R in the upper-lower direction and contacts the heat dissipation member 22. The recess 23Y overlaps (faces) the outer peripheral regions 13S and 14S in the upper-lower direction. The pressing member 21 is disposed in the recess 23Y. The heat dissipation member 23 is made of metal such as copper and aluminum, graphite, and so on.

As shown in FIG. 5, two water cooling pipes 24 are attached to the heat dissipation member 23. The water cooling pipes 24 are an example of “first water cooling pipe” of the present disclosure.

As shown in FIG. 7, each water cooling pipe 24 has two vertical portions 241 extending in the upper-lower direction and one horizontal portion 242 connecting the two vertical portions 241. The horizontal portion 242 extends in a horizontal direction and is disposed in a groove formed in the upper surface of the heat dissipation member 23 via a heat transfer material A. The water cooling pipe 24 is made of metal such as stainless steel (SUS), copper, and aluminum. The heat transfer material A is made of grease, for example, and is disposed between the water cooling pipe 24 and the heat dissipation member 23.

As shown in FIG. 5, the horizontal portions 242 of the two water cooling pipes 24 are spaced apart from each other in the front-rear direction and extend in the left-right direction. The three circuit boards 17 are disposed between the two horizontal portions 242 in the front-rear direction.

The circuit boards 17 are disposed above the heat dissipation member 22 and in a recess provided in the upper surface of the heat dissipation member 23, and is electrically connected to the COF 14. The two water cooling pipes 24 overlap the circuit boards 17 in the front-rear direction and are arranged at positions sandwiching the circuit boards 17. The front-rear direction is an example of “first direction” of the present disclosure, and the left-right direction is an example of “second direction” of the present disclosure.

As shown in FIG. 5, the support member 16 is formed by three plates stacked in the upper-lower direction, and supports the three circuit boards 17 on the lower surface. The support member 16 is disposed between the heat dissipation member 23 and the driver ICs 15A, 15B in the upper-lower direction.

The heat dissipation member 18 is disposed above the driver ICs 15A and 15B. The heat dissipation member 18 contacts the upper surfaces of the two driver ICs 15A and 15B. The heat dissipation member 18 is made of a material having high heat conductivity, such as a metal, and has a function of dissipating heat from the driver ICs 15A and 15B. The heat dissipation member 18 is an example of “second heat sink (third heat dissipation member)” of the present disclosure.

As shown in FIG. 5, a water cooling pipe 25 is attached to the heat dissipation member 18. The water cooling pipe 25 is an example of “second water cooling pipe” of the present disclosure.

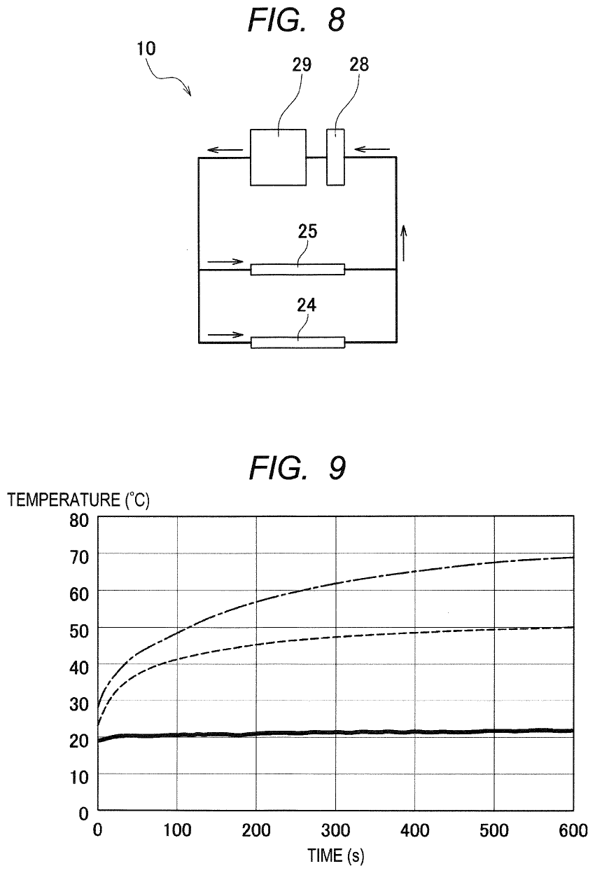

As shown in FIG. 8, the head 10 includes a water tank 29 and a cooler 28 which communicate with both of the water cooling pipes 24 and 25. The water tank 29 is an example of “water source” of the present disclosure. The water tank 29 stores water cooled by the cooler 28. The cooling water in the water tank 29 is fed to each of the water cooling pipes 24 and 25. The water that has passed through the water cooling pipes 24 and 25 is sent to the cooler 28, cooled by the cooler 28, and then stored in the water tank 29.

FIG. 9 shows temperature changes of the head 10 associated with the driving of the actuator member 13 in the embodiment and comparative examples. In FIG. 9, the solid line indicates the analysis result of the embodiment, the broken line indicates the analysis result of a first comparative example, and the single-dot chain line indicates the analysis result of a second comparative example. The first comparative example is a model in which the pressing member 21 and the heat dissipation members 22 and 23 are omitted from the embodiment. The second comparative example is a model in which the pressing member 21 and the heat dissipation members 18, 22, and 23 are omitted from the embodiment. It is understood from FIG. 9 that, in the embodiment, the effect of suppressing a temperature rise of the head 10 is higher than in the comparative examples.

As described above, according to the embodiment, as shown in FIG. 5, the pressing member 21 presses the outer peripheral region 14S of the connection portion 141 toward the actuator member 13, thereby preventing the COF 14 from separating from the actuator member 13. Further, the heat dissipation member 22 having a low hardness contacts the contact region 14R of the connection portion 141, thereby releasing the heat of the actuator member 13 without applying a load to the bonding portion of the contacts 139 and 149 (see FIG. 2).

The heat dissipation member 22 is made of gel. Thus, the hardness of the heat dissipation member 22 is low, which more reliably realizes the effect of not applying a load to the bonding portion of the contacts 139 and 149 (see FIG. 2).

The heat dissipation member 23 made of metal contacts the heat dissipation member 22 (see FIG. 5). Thus, the heat of the heat dissipation member 22 is released via the heat dissipation member 23, and the heat of the actuator member 13 is released more efficiently.

The heat dissipation member 23 may be made of copper. Copper has high thermal conductivity and thus has excellent heat dissipation properties, and is easy to process and inexpensive. In addition, in a case where the water cooling pipe 24 is made of stainless steel (SUS), copper is compatible with stainless steel (SUS), and thus corrosion or electrolytic corrosion is unlikely to occur.

The heat dissipation member 23 may be made of graphite. Graphite has high thermal conductivity and thus has excellent heat dissipation properties, and is easy to process and is an inexpensive material.

The water cooling pipes 24 are attached to the heat dissipation member 23 (see FIG. 5). Thus, the heat dissipation member 23 is cooled via the water cooling pipes 24, which more efficiently realize releasing the heat of the heat dissipation member 22 and thus releasing the heat of the actuator member 13.

The two water cooling pipes 24 are disposed at positions overlapping the circuit boards 17 and sandwiching the circuit boards 17 in the front-rear direction (that is, when viewed in the front-rear direction) (see FIG. 5). Thus, the two water cooling pipes 24 arranged so as to avoid the circuit boards 17 achieve uniform temperature of the heat dissipation member 23.

The heat transfer material A is disposed between the water cooling pipes 24 and the heat dissipation member 23 (see FIG. 5). This allows heat to be efficiently transferred from the heat dissipation member 23 to the water cooling pipes 24, and the heat of the heat dissipation member 22 and also the heat of the actuator member 13 are more efficiently released.

The water tank 29 communicates with both the water cooling pipes 24 attached to the heat dissipation member 23 and the water cooling pipe 25 attached to the heat dissipation member 18 (see FIG. 8). Thus, the water source of the water cooling pipes 24 and 25 is common, which simplifies the configuration.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

The channel member is not limited to a serial type, and may be a line type.

The target object onto which liquid is ejected from the nozzle is not limited to a sheet of paper, and may be, for example, a cloth, a substrate, a plastic member, and so on.

The liquid ejected from the nozzle is not limited to ink, and may be any liquid. For example, the liquid may be a treatment liquid that causes components in the ink to aggregate or precipitate.

The present disclosure is not limited to a printer, and is also applicable to a facsimile, a copier, a multifunction peripheral, and so on. The present disclosure is also applicable to a liquid ejection apparatus used for purposes other than image recording. For example, the liquid ejection apparatus may be a liquid ejection apparatus that forms a conductive pattern by ejecting a conductive liquid onto a substrate.

What is claimed is:

1. A liquid ejection head comprising:
a channel member having a liquid channel including a nozzle;
an actuator member disposed on an upper surface of the channel member, the actuator member having an upper surface including a first contact region in which a first contact is disposed and a first outer peripheral region surrounding the first contact region, the actuator member being configured to cause the nozzle to eject liquid;
a wiring member including a connection portion disposed on the upper surface of the actuator member, the connection portion including a second contact region and a second outer peripheral region, the second contact region overlapping with the first contact region in a perpendicular direction perpendicular to the upper surface of the actuator member, a second contact electrically connected to the first contact being disposed in the second contact region, the second outer peripheral region overlapping with the first outer peripheral region in the perpendicular direction;
a pressing member disposed above the connection portion, the pressing member contacting the second outer peripheral region without contacting the second contact region, the pressing member being configured to press the second outer peripheral region toward the actuator member; and
a thermal interface material disposed above the connection portion, the thermal interface material contacting the second contact region without contacting the second outer peripheral region, the thermal interface material having a lower hardness than the pressing member.

2. The liquid ejection head according to claim 1, wherein the thermal interface material is made of gel.

3. The liquid ejection head according to claim 1, further comprising a first heat sink disposed above the thermal interface material and contacting the thermal interface material.

4. The liquid ejection head according to claim 3, wherein the first heat sink is made of copper.

5. The liquid ejection head according to claim 3, wherein the first heat sink is made of graphite.

6. The liquid ejection head according to claim 3, further comprising a first water cooling pipe attached to the first heat sink.

7. The liquid ejection head according to claim 6, further comprising:
a circuit board disposed above the thermal interface material, the circuit board being electrically connected to the wiring member; and
an other first water cooling pipe attached to the first heat sink,
wherein the first water cooling pipe and the other first water cooling pipe are arranged to overlap with the circuit board in a first direction, the first direction being parallel to the upper surface of the actuator member, the circuit board being disposed between the first water cooling pipe and the other first water cooling pipe in the first direction; and
wherein each of the first water cooling pipe and the other first water cooling pipe extends in a second direction, the second direction being parallel to the upper surface of the actuator member and crossing the first direction.

8. The liquid ejection head according to claim 6, wherein a heat transfer material is arranged between the first water cooling pipe and the first heat sink.

9. The liquid ejection head according to claim 6, further comprising:
a driver circuit disposed at an other portion of the wiring member, the other portion being other than the connection portion;
a second heat sink contacting the driver circuit;
a second water cooling pipe attached to the second heat sink; and
a water source communicating with both of the first water cooling pipe and the second water cooling pipe.

10. The liquid ejection head according to claim 1, wherein the wiring member further includes a folded portion, the folded portion including a vertical portion and a horizontal portion, the vertical portion extending upward from an end of the connection portion in a first direction that is parallel to the upper surface of the actuator member, the horizontal portion extending in the first direction from an upper end of the vertical portion toward a center of the wiring member in the first direction; and
wherein the liquid ejection head further comprises:
a driver circuit disposed on an upper surface of the horizontal portion; and
a heat sink contacting the driver circuit.

11. A printer comprising:
a conveyor configured to convey a sheet; and
a liquid ejection head configured to eject liquid onto the sheet conveyed by the conveyor, the liquid ejection head comprising:
a channel member having a liquid channel including a nozzle;
an actuator member disposed on an upper surface of the channel member, the actuator member having an upper surface including a first contact region in which a first contact is disposed and a first outer peripheral region surrounding the first contact region, the actuator member being configured to cause the nozzle to eject liquid;
a wiring member including a connection portion disposed on the upper surface of the actuator member, the connection portion including a second contact region and a second outer peripheral region, the second contact region overlapping with the first contact region in a perpendicular direction perpendicular to the upper surface of the actuator member, a second contact electrically connected to the first contact being disposed in the second contact region, the second outer peripheral region overlapping with the first outer peripheral region in the perpendicular direction;
a pressing member disposed above the connection portion, the pressing member contacting the second outer peripheral region without contacting the second contact region, the pressing member being configured to press the second outer peripheral region toward the actuator member; and
a thermal interface material disposed above the connection portion, the thermal interface material contacting the second contact region without contacting the second outer peripheral region, the thermal interface material having a lower hardness than the pressing member.
